(19) United States
(12) Patent Application Publication
(10) Pub. No.: US 2025/0392205 A1
(43) Pub. Date: Dec. 25, 2025

(54) CAPACITORLESS SOLID-STATE POWER FILTER FOR POWER CONVERTERS AND ELECTRICAL POWER SYSTEMS

(71) Applicant: The Trustees of Indiana University, Bloomington, IN (US)

(72) Inventors: Euzeli Cipriano dos Santos, Jr., Zionsville, IN (US); Haitham Kanakri, Indianapolis, IN (US)

(21) Appl. No.: 19/242,101

(22) Filed: Jun. 18, 2025

Related U.S. Application Data
(60) Provisional application No. 63/663,832, filed on Jun. 25, 2024.

(51) Int. Cl. H02M 1/12; H02J 3/01; H02J 3/38; H02J 4/00; H02M 7/5387

(52) U.S. Cl. CPC H02M 1/12; H02J 3/01; H02J 3/38; H02J 4/00; H02M 7/53871; H02J 2300/24; H02J 2310/42; H02J 2310/44

(57) ABSTRACT

Capacitorless solid-state power filter for power converters and electrical power systems. The capacitorless solid-state power filter has a high-frequency planar transformer and a high-frequency power converter. The capacitorless solid-state power filter injects voltage harmonics into the output voltage of a power converter or other source of raw voltage to attain a smoothed output voltage suitable for a given electrical load component. The capacitorless solid-state power filter can be implemented with a DC-DC and/or a DC-AC power converter to provide a smoothed output voltage, such as a flat wave (DC) or a sinusoidal wave (AC). The power converter is capable of generating a smoothed output voltage without relying on capacitors. The capacitorless solid-state power filter may be incorporated into different types of electrical power systems, such as marine systems, aeronautic systems, and/or utility power grids.

### CROSS-REFERENCE TO RELATED APPLICATIONS

This application claims the benefit of U.S. Provisional Application No. 63/663,832 filed Jun. 25, 2024, the contents of which are incorporated herein by reference.

### BACKGROUND OF THE INVENTION

The invention generally relates to capacitorless solid-state power filter for power converters and electrical power systems.

Power converters convert one type of electrical power to a second type of electrical power. AC-DC power converters convert AC voltage into DC voltage, whereas DC-AC power converters convert DC voltage into AC voltage. Power converters, however, typically introduce significant harmonics into the voltage signal and/or provides a signal that is not as smooth as needed, which, for higher precision electronics applications, is typically undesirable. To overcome this problem power converters are often provided with power filters that operate to smooth the output voltage to more precisely provide the desired voltage wave.

Many conventional power converters rely on passive filtering as a crucial element due to the high-frequency operational characteristics of power electronics. Many traditional filtering methods involve a dual inductor-capacitor (LC) cell or an inductor-capacitor-inductor (LCL) T-circuit to filter the output voltage. In many conventional power filters, electrolytic capacitors are used. However, these capacitors are susceptible to multiple types of wear mechanisms and failure modes. The necessity for monitoring and regular replacement of these capacitors adds to the cost of ownership for such systems. To overcome some limitations of the typical passive filtering techniques, active output filtering techniques have been developed.

FIG. 1 illustrates an example of a conventional single-phase power filter that implements active output filtering. The active output filter is defined as semiconductor filter block, which is a departure from the conventional LC output filters. The active output filter integrates an H-bridge converter, operating at high frequency to inject voltage harmonics, to attain a sinusoidal output load voltage. Although the active output filter achieves a substantial reduction in the size of the typical output LC filter, this design nevertheless requires the incorporation of a passive LC filter and an external dc-link capacitor that adds complexity to the design of the passive LC output filter.

While there some single-phase and three-phase power converters that purport to be capacitorless, upon closer inspection, it can be seen that they still require some small capacitance element.

In all of these conventional power converters, the capacitors are a weak spot due to their relative short lifespan in comparison to other components in an electrical system. The short lifespan of capacitors in power electronics converters poses a significant challenge for engineers and manufacturers. These capacitors play a crucial role in smoothing voltage and filtering out unwanted frequencies, but their vulnerability to heat, ripple current, and aging can lead to premature faults. This can trigger cascading undesirable effects, such as output voltage instability, short circuits, and ultimately resulting in catastrophic failure and system shutdown. In fact, it has been estimated that capacitors are responsible for 30% of power electronics failures. Therefore, it would be desirable to have a power filter and/or power converter that is truly without capacitors and yet can provide suitable power smoothing for precision electronics circuits.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, a capacitorless solid-state power filter, a power converter, and an electrical power system.

According to a nonlimiting aspect, a capacitorless solid-state power filter for an electrical system includes a high-frequency planar transformer and a high-frequency converter. A first winding of the high-frequency planar transformer is configured to receive a raw input voltage and connect with a load. The high-frequency converter is operatively coupled to a second winding of the high-frequency planar transformer. The high-frequency converter is configured to generate voltage harmonics that, when added to the raw input voltage, transform the raw input voltage into a smoothed output voltage for the load. The power filter does not include a capacitor.

According to another nonlimiting aspect, a power converter includes a low-frequency converter configured to convert a first voltage to a raw input voltage and the capacitorless solid-state power filter described above. The capacitorless solid-state power filter is operatively coupled with the low-frequency converter to receive the raw input voltage. The capacitorless solid-state power filter generates voltage harmonics that, when added to the raw input voltage, transform the raw input voltage into a smoothed output voltage for an electrical load.

According to yet another nonlimiting aspect, an electrical power system includes a source of raw input voltage, the capacitorless solid-state power filter described above, and an electrical load. The capacitorless solid-state power filter is operatively connected to the source to receive the raw input voltage and transform the raw voltage into a smoothed output voltage. The electrical load is operatively connected to the capacitorless solid-state power filter to receive the smoothed output voltage.

Technical aspects of capacitorless solid-state power filters as described above preferably include the ability to achieve longer lives and lower operating costs than conventional power filters due to not needing to use conventional capacitors.

These and other aspects, arrangements, features, and/or technical effects will become apparent upon detailed inspection of the figures and the following description.

### BRIEF DESCRIPTION OF THE DRAWINGS

FIG. 1 is a schematic diagram of a conventional single-phase active output power filter.

FIG. 2 is a schematic diagram of a capacitorless solid-state power filter (SSPF) according to certain aspects of the invention.

FIG. 3 is a schematic diagram of a single-phase DC-AC converter according to certain aspects of the invention and incorporating the capacitorless solid-state power filter of FIG. 2.

FIGS. 4A-4C schematically illustrate various use examples suitable for implementing the capacitorless solid-state power filter of FIG. 2 or the converter of FIG. 3 for power smoothing. FIG. 4A represents an electric power system in a marine vessel, FIG. 4B represents an electric power system in an aircraft, and FIG. 4C represents a photovoltaic system for providing reliable electric power to an electric power grid.

FIG. 5 illustrates an example of the SSPF constructed without capacitance and implemented with a switch unit connected to a planar transformer for generating gate signals.

FIGS. 6A-6C illustrate the spectrum of the main voltages produced by the SSPF DC-AC converter: (FIG. 6A) main H-bridge converter output; (FIG. 6B) transformer output primary; and (FIG. 6C) transformer output.

FIGS. 7A-7C illustrate voltages used to synthesize a sinusoidal load voltage, in which for each figure, the top graph represents the line-to-line voltage v₁₂, and the bottom graph represents the output voltage v′_{ab} from the planar transformer. FIG. 7A represents the voltages for δ=0°, FIG. 7B represents the voltages for δ=30°, and FIG. 7C represents the voltages for δ=60°.

FIGS. 8A-8C are graphs of simulation results for the case of δ=60°, showing the main waveforms (from top to bottom) v₁₂, v_{ab}, v′_{ab}, iₚ, iₒ, and vₒ. FIG. 8A is for a transformer turns ratio of n=1:1, FIG. 8B is for a transformer turns ratio of n=2:1, and FIG. 8C is for a transformer turns ratio of n=1:2.

FIGS. 9A and 9B are graphs of experimental results showing the main waveforms (from top to bottom) v₁₂, v′_{ab}, vₒ, and iₒ. FIG. 9A shows multiple cycles, and FIG. 9B shows a single cycle.

FIGS. 10A and 10B are graphs of experimental results showing the main waveform (from top to bottom) v₁₂, v′_{ab}, vₒ, and iₒ. FIG. 10A shows the start-up procedure start up with the input voltage ramping up from zero to rated voltage in 25 ms. FIG. 10B shows a load transient from 10Ω to 16Ω.

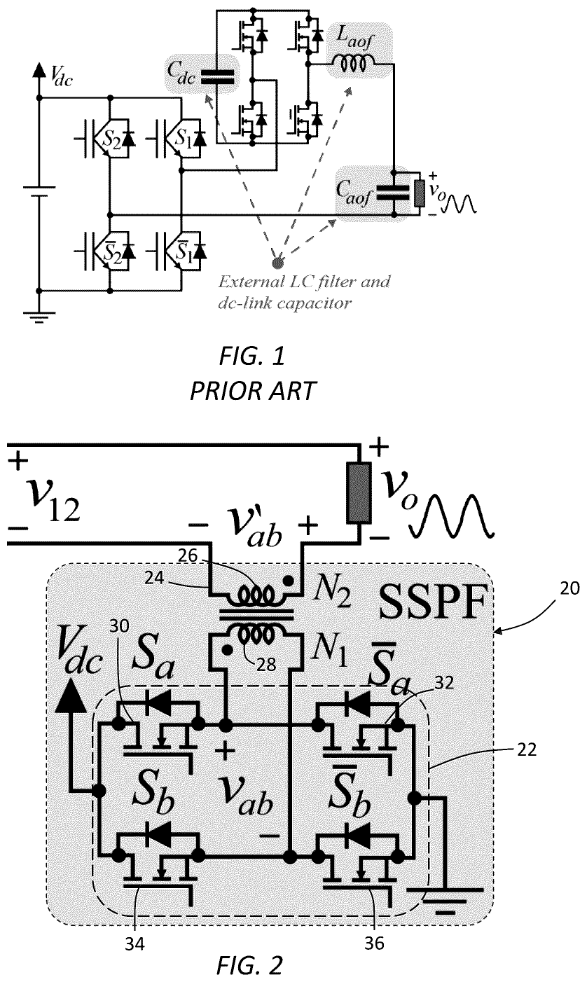

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite particularly point out subject matter regarded as aspects of the invention, including certain but not necessarily all of the aspects and alternatives described in the detailed description.

Although the invention will be described hereinafter in reference to embodiments of DC-AC power converters represented the drawings, it will be appreciated that the teachings of the invention are also more generally applicable to a variety of types of power converters, such as, but not limited to, DC-DC power converters and AC-DC power converters.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

In some nonlimiting aspects, the present invention provides a capacitorless solid-state power filter (SSPF) that can be implemented with a DC-DC and/or a DC-AC power converter to provide a smoothed output voltage, such as a flat wave (DC) or a sinusoidal wave (AC). In some embodiments, the SSPF can be configured for single-phase DC-AC converters. The DC-AC power converter is preferably capable of generating a sinusoidal AC voltage without relying on capacitors. The example SSPF includes a planar transformer and an H-bridge converter operating at high frequency, and injects voltage harmonics into the output voltage of the power converter to attain a smoothed sinusoidal output voltage.

Turning now to the nonlimiting embodiments represented in the drawings, FIG. 2 depicts a high-frequency solid-state power filter (hereinafter, simply the “power filter” or “SSPF”) 20 according to one nonlimiting example embodiment of the invention that does not require or incorporate any capacitors. Thus, the power filter 20 may also be referred to as a capacitorless SSPF or capacitorless power filter. In this embodiment, the SSPF 20 is configured for generating voltage harmonics that, when added to a stepwise AC voltage received from a DC-to-AC (hereinafter, simply “DC-AC”) converter, transform the stepwise AC voltage into a smoothed sinusoidal AC voltage. However, the SSPF 20 can be readily reconfigured for smoothing voltage from a DC-to-DC (hereinafter, simply “DC-DC”) power converter and/or an AC-DC power converter in accordance with the principles disclosed herein.

The capacitorless power filter 20 is represented in FIG. 2 as including a high-frequency solid-state converter 22 and a high-frequency planar transformer 24. The solid-state converter 22 and the planar transformer 24 preferably operate in the kilohertz range, such as between about 10 kHz and about 90 kHz, and in some embodiments between about 60 kHz and about 80 kHz.

The planar transformer 24 includes a first winding 26 and a second winding 28. The first winding 26 is configured to be electrically connected to a received voltage, such as a voltage (e.g., V₁₂) received from an inverter, converter, or other source of “raw” voltage that may need smoothing, and a load that requires a load voltage (e.g., Vₒ). Thus, the planar transformer 24 is connected in series to the load. The second winding 28 is electrically connected to the solid-state converter 22.

The solid-state converter 22 in this example is formed by a solid-state H-bridge converter unit, which includes four metal-oxide semiconductor field-effect transistors (MOSFETs) 30, 32, 34, and 36. In this embodiment, each of the MOSFETs 30 to 36 are N-channel MOSFETs; although other MOSFETs could be used for different smoothing applications, such as for a DC-DC converter. The first and second MOSFETs 30 and 32 are electrically connected to a first terminal of the second winding 28 (indicated as a positive terminal in the drawing), and the third fourth MOSFETs 34 and 36 are electrically connected to a second terminal of the second winding (indicated as a negative terminal in the drawing). More specifically, the positive terminal of the second winding 28 is connected to the source of the first MOSFET 30 and the drain of the second MOSFET 32, and the negative terminal of the second winding 28 is connected to the source of the third MOSFET 34 and the drain of the fourth MOSFET 36. The sources of the second and fourth MOSFETs 32 and 36 are electrically connected to ground. The drains of the first and third MOSFETs 30 and 34 are connected to a source voltage (Vdc). A semiconductor diode is electrically connected across the corresponding source and the drain of each MOSFET 30 to 36 in parallel with the corresponding gate. Each MOSFET-diode pair 30, 32, 34 and 36 forms a switch labeled Sₐ, S̅ₐ, S_{b}, S̅_{b}, in the drawing, respectively.

The solid-state converter 22 may be operatively connected to a controller configured to control the gates of the MOSFETs to generate the desired voltage harmonics. For example, the controller may be programmed to generate the gate signals for each of the MOSFETs 30, 32, 34 and 36 in the MOSFET-diode pair switches so as to generate voltage harmonics selected and designed to provide a specific smoothing and/or shaping high-frequency voltage harmonic that will transform a particular raw voltage wave into a desired smoothed voltage wave.

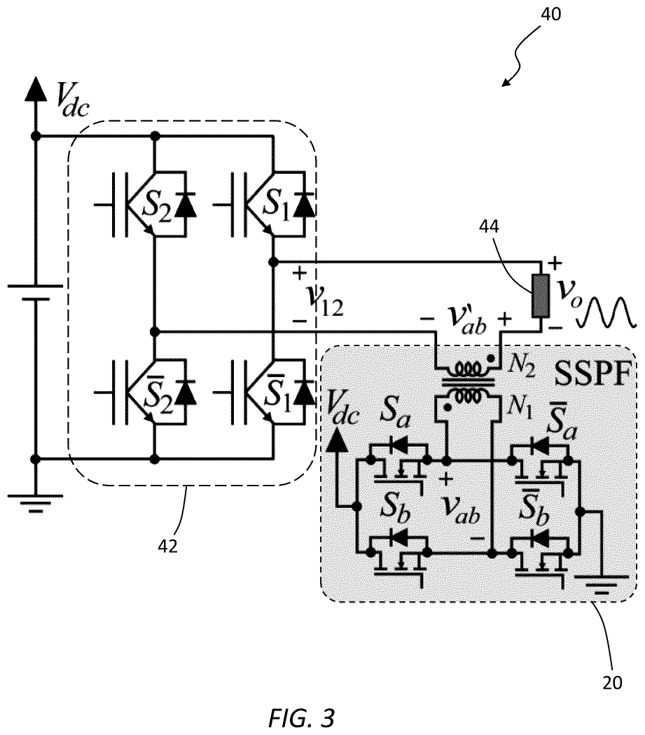

Turning now to FIG. 3, a power converter 40 according to additional aspects of the invention includes a low-frequency converter 42 and the capacitorless power filter 20. The low-frequency converter 42 typically operates in the Hz range, such as between about 10 Hz and about 900 Hz. In some embodiments, the low-frequency converter 42 operates between about 50 Hz and about 400 Hz. In this embodiment, the low-frequency converter 42 is an H-bridge converter configured to generate a stepwise AC voltage from a DC voltage. However, other embodiments may incorporate other types of low-frequency converters. For example, in some embodiments, the low-frequency converter 42 could be configured as a DC-DC converter. The capacitorless power filter 20 is electrically conned in series between the output voltage from the low-frequency converter 42 and an electrical load 44 (e.g., a motor, computer, lamp, etc.). In this example, the first terminal of the first winding 26 (indicated as the negative terminal in the drawings) is connected with the low-frequency converter 42 and the second terminal of the first winding 26 (indicated as the n terminal in the drawings) is connected with the load 44.

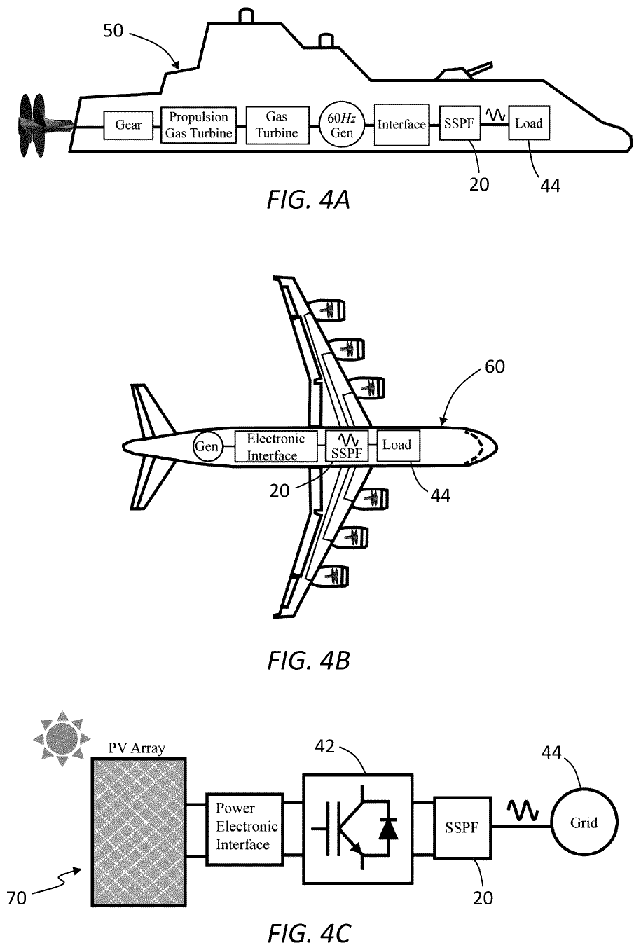

Turning now to FIGS. 4A-4C, the power converter 40 and/or the capacitorless power filter 20 are suitable for application in a broad array of electrical power systems to receive a raw voltage that has a shape or harmonics that are not desirable for a given use from a voltage source (e.g., a generator or a battery or photovoltaic system) and transform the raw voltage into a smoothed output voltage for example by shaping and/or smoothing the raw voltage. In one example, the capacitorless power filter 20 may be incorporated into the electric power system of a marine vessel 50. In one such embodiment, the capacitorless power filter 20 may be incorporated in the power generation units for ships and combatant vessels, where the power grid operates at 60 Hz, as shown in FIG. 4A. In another example, the capacitorless power filter 20 may be incorporated into the electrical power systems of an aircraft 60. In one such embodiment shown in FIG. 4B, the capacitorless power filter 20 is incorporated into the power generation units of aircraft where the power grid operates at 400 Hz. In yet another example, the capacitorless power filter 20 may be configured with a DC-AC power converter (e.g., 40) in the electrical power system of a photovoltaic system 70 coupled to a utility power grid, such as a typical 50 Hz (e.g., in the U.S.) or 60 Hz (e.g., in Europe) electrical power grid. In one such embodiment shown in FIG. 4C, the capacitorless power filter 20 is incorporated as the unit interfacing renewable energy systems, such as a photovoltaic system, with the local utility power grid. In this scenario, use of the capacitorless power filter 20 may be particularly desirable when high reliability is a critical need.

A single-phase DC-AC converter in accordance with the present invention may be particularly useful for conditions where capacitors are not recommended for specific applications. The topology of the DC-AC converter has two parts: a low-frequency H-bridge converter and an SSPF capable of generating a sinusoidal voltage output for the load. The example embodiment of FIG. 3 illustrates the elimination of passive components, setting this design apart from previously known designs.

Next, modelling, gate signal generation, and the operation principle of the single-phase DC-to-AC power converter 40 are explained. The SSPF 20 constructed without capacitance is implemented with a high-frequency H-bridge unit (switches Sₐ, S̅ₐ, S_{b}, S̅_{b}) connected to a high-frequency planar transformer that is, in turn, series connected to the loads expected from a filter, the SSPF 20 is responsible to cancel out the harmonics produced by the main H-bridge converter (i.e., switches S₁, S̅₁, S₂, and S̅₂) that operates at low frequency, e.g., 60 Hz for a grid-tie applications or 400 Hz for aerospace grid systems. From FIG. 3, and considering that Sⱼ(j=1,2, a, and b) represents the state of each switch, with Sⱼ=1 meaning switch is ON and Sⱼ=0 switch is OFF, the load voltage can then be written as:

$${v}_{O} = {v}_{12} - {v}_{ab}^{′} \qquad Eq . 1$$

$${v}_{12} = ( {S}_{{1}^{-}} {S}_{2} ) {V}_{dc} \qquad Eq . 2$$

$${v}_{ab =}^{′} n {\hat{u}}_{ab} \qquad Eq . 3$$

where n is the transformer

$$n = \frac{N 2}{N 1}$$

and û_{ab} is the voltage with low-order harmonics (not included the harmonics due to the switching frequency) of v_{ab}, which is given by:

$${v}_{ab = ( Sa - Sb )} {V}_{d c} \qquad Eq . 4$$

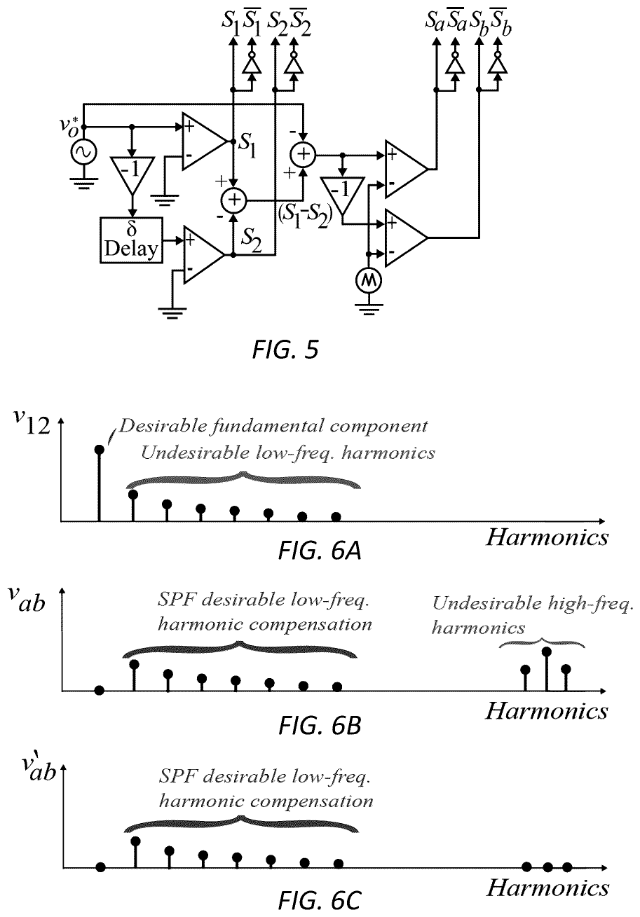

The block diagram in FIG. 5 shows schematically how the gate signals (S₁, S₂, S₃, and S₄) are obtained. Due to its operation at low frequency, the main H-bridge (i.e., switches S₁, S̅₁, S₂, and S̅₂) generates the fundamental component for the load voltage along with undesirable low-frequency harmonics that needs to be compensated by the SSPF 20, see FIG. 6A. On the other hand, FIG. 6B, shows the spectrum of the voltage produced by the SSPF 20 (i.e., the spectrum of v_{ab}), which has desirable low-frequency harmonics components along with undesirable high-frequency components. Those high-frequency components are attenuated by the planar transformer that has inherently higher leakage inductance, and the undesirable high-frequency harmonics are effectively removed as illustrated in FIG. 6C.

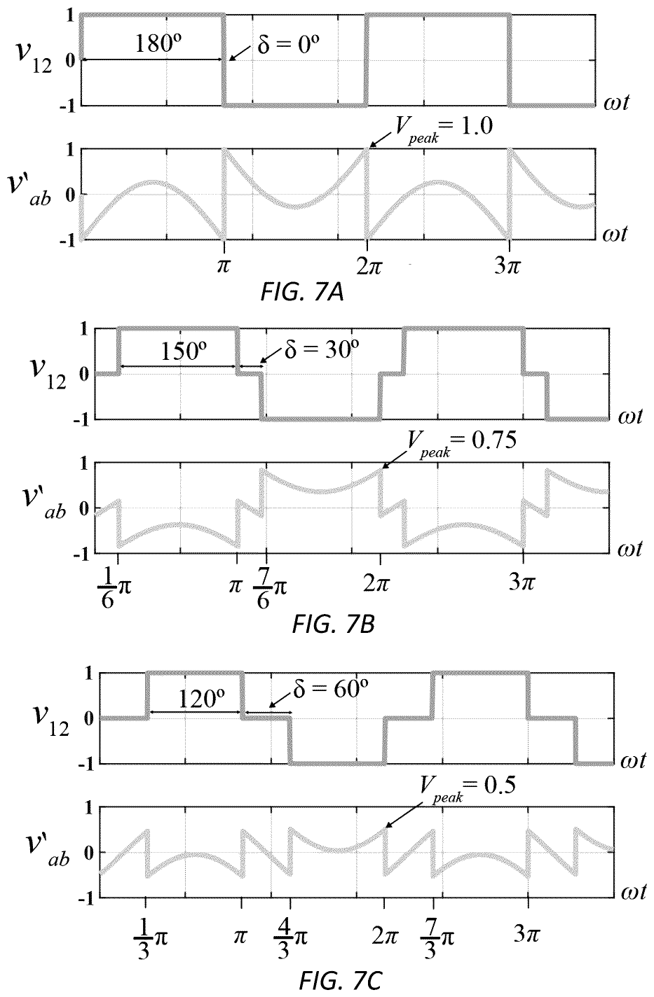

FIGS. 7A-7C show how the peak voltage (v′_{ab}) at the secondary winding of the transformer changes with the value of δ°. The amount of voltage required at the primary of the transformer is higher than what can be processed by the high-frequency transformer when n=1/2 and δ=0°, and δ=30°. On the other hand, when δ=60°, the maximum voltage V_{ab} is equal to the dc-link voltage. Making n=1/2 is favorable because it reduces the current at the SSPF converter. In view of this, the gate control signals (S₁, S₂, S₃, and S₄) can be derived to generate a desired shape and smoothing of unwanted harmonics in essentially any given voltage wave.

The basic operational principle of the SSPF 20 is to add (superimpose) a transformative voltage wave and/or harmonics onto the raw voltage wave coming from the low-frequency converter 42 using the planar transformer 24 to transform the raw voltage wave into a smoothed voltage suitable for the load 44. For example, the converter voltage v₁₂, for δ=0° shown in FIG. 7A is represented through a Fourier series that incorporates all odd harmonics. As shown in the top graph of FIG. 7A, the inverter's voltage is a two-level stepwise waveform with a phase shift parameter δ set to 0°. The injected (i.e., added/superimposed) voltage v′_{ab} from the SSPF 20 to be provided from the secondary side (secondary winding 26) of the planar transformer 24 necessary to obtain the desired smoothed/shaped output voltage waveform for a given load requirement can be obtained from mathematical calculations. In this example, the injected voltage V′_{ab} has been derived so as to produce a resulting output voltage vₒ, which is the summation of the raw input voltage from the low-frequency converter 42 superimposed with the injected voltage v′_{ab}, for the load 44 that is sinusoidal. The case of δ=0° is the optimal scenario for maximizing the load voltage avoid the de-link voltage. The de-link current can be described in terms of the switching functions both the inverter's switches (S₁, S₂) and the SSPF switches (Sₐ, S_{b}). Similar analyses for the scenarios of δ=30° and δ=60°, shown in FIGS. 7B and 7C, respectively.

The use of the planar transform 24 in the SSPF 20 provides several advantages over traditional transformers. A planar transformer, in contrast to a traditional transformer built with wires, is constructed with printed circuit board (PCB) that has inherent high leakage inductance beneficial for the capacitorless SSPFs disclosed herein. Planar transformers are integrated into power electronics converters because of their high-power density, superior performance, mechanical robustness, improved thermal characteristics and cost effectiveness. Planar transformers can operate at high frequencies, often in the range of several tens of kilohertz. In addition, planar transformers are constructed with high precision, with each primary turn and secondary turn positioned precisely within the core according to PCB layouts, which facilitates better control over main variables, especially the leakage inductances. Design of the SSPF planar transformer 24 for use in a particular application (e.g., a ship, airplane, automotive, computer, power grid, etc. electrical system) can be readily calculated using known design techniques to design a specific layout, core parameters, numbers of turns for the respective windings, etc., needed to meet the parameters for the given application.

Two transformer models were constructed using Ferroxcube U100/57/25-3C90 core, 2 oz of copper winding and 1.6 [mm] FR4 thickness. A first of the models has a turns ratio of 1:1, and the second model has a turns ratio of 2:1. Investigations of the impact of various transformer parameters on the quality of the output load voltage showed that the increased magnetizing inductance has the potential to significantly reduce the total harmonic distortion of the output voltage. This effect appears to be because the transformer operates more closely to an ideal voltage source when characterized by higher magnetizing inductance. Therefore, all the low-frequency harmonic components deemed desirable in FIGS. 6A-6C will present on the secondary side of the transformer (i.e., the load side) without distortion. Meanwhile, the leakage inductance serves as a crucial component in filtering out high-frequency harmonics, specifically those arising from the elevated pulse-width modulation (PWM) switching frequency.

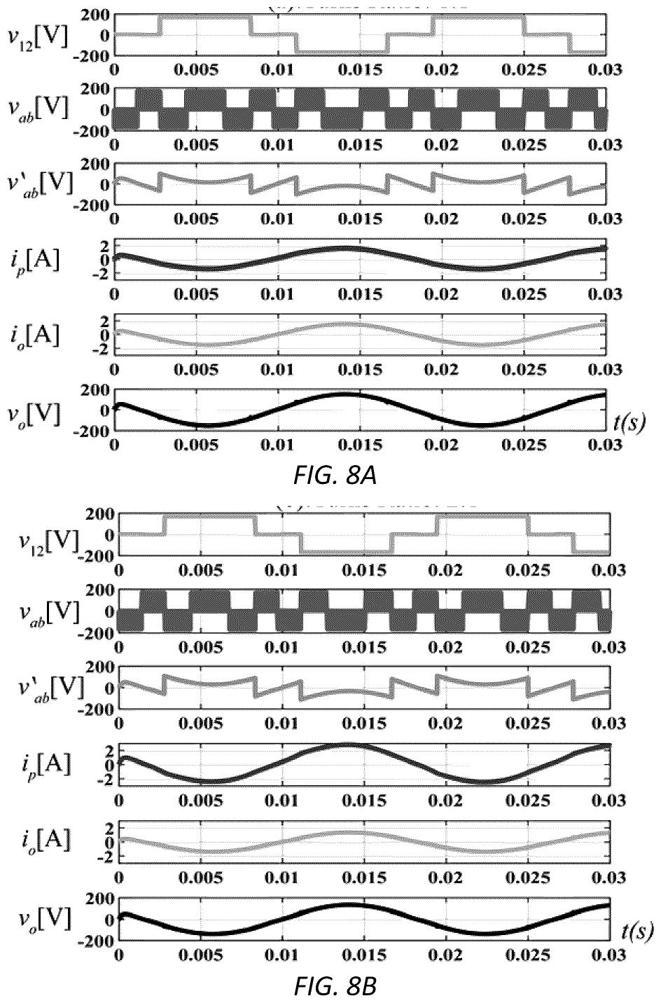

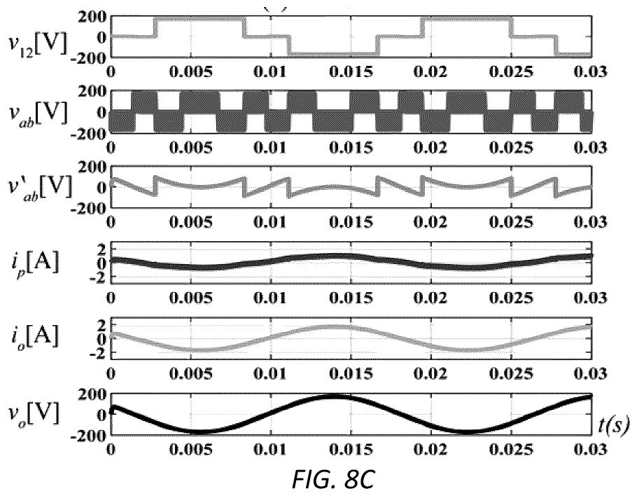

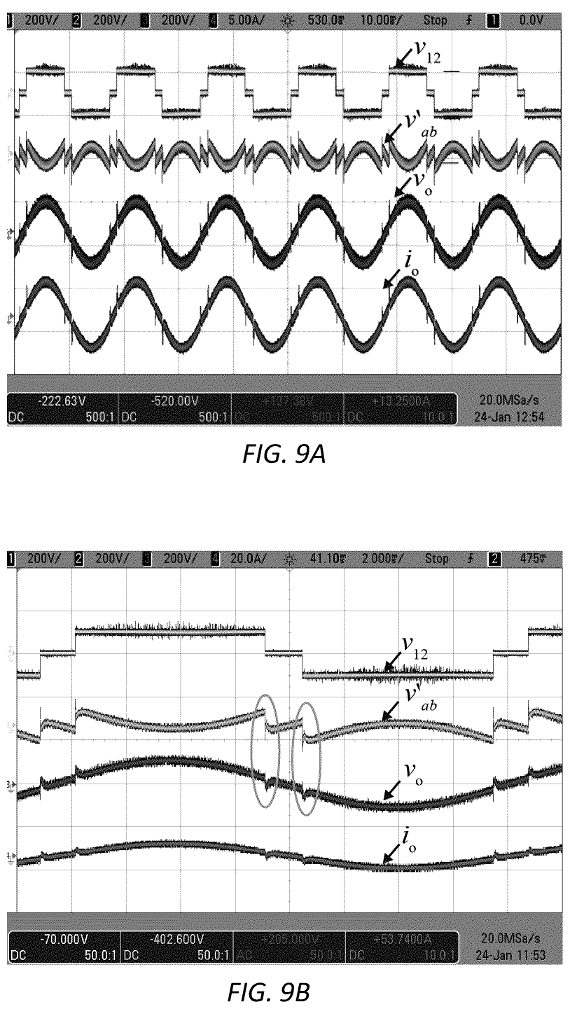

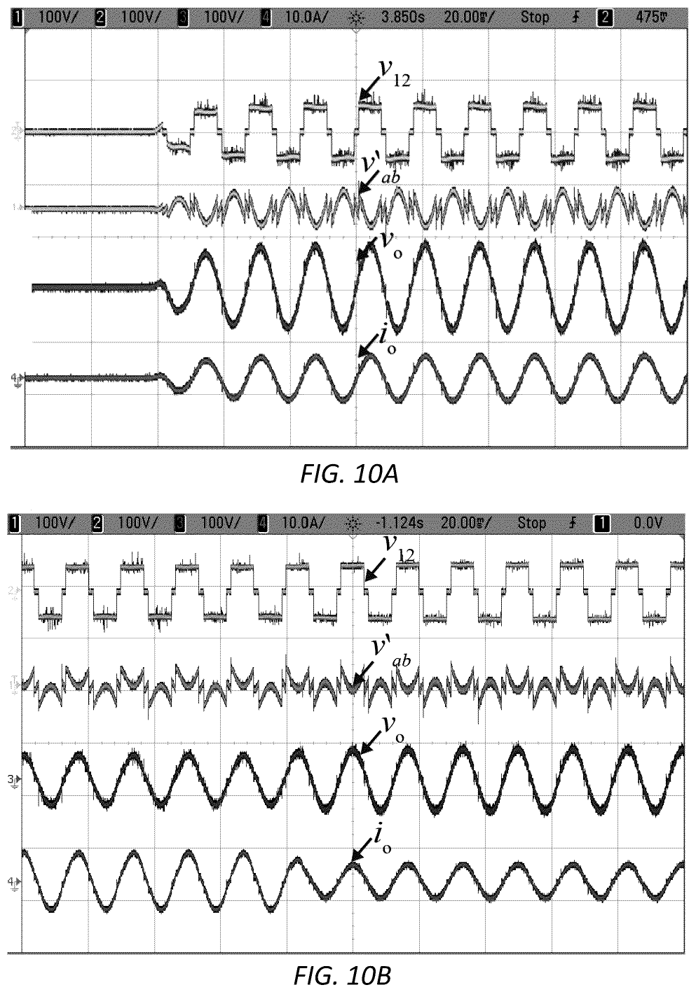

An experimental prototype was constructed to have an inverter board part, an SSPF board part, and a customized control board. The SSPF board was built with an Infineon IM828XCCXKMA1 MOSFET (80 kHz, 1200 V, 20 A) integrated circuit, which includes a three-phase inverter with 1200V MOSFETs with body diodes that can be used as free-wheeling diodes combined with a 6-channel SOI gate driver. The inverter was built with an Infinion IRAMY20UP60B IGBT integrated power hybrid integrated circuit module. The control board was built with a Microchip dspic33EP128GS808 microcontroller, an SMPS digital power conversion digital signal controller. The microcontroller was programmed to generate the gate signals as presented in FIG. 5. FIGS. 8A, 8B, and 8C present the same set of simulation results for the main waveforms: inverter output line to line voltage v₁₂, transformer primary voltage v_{ab}, transformer secondary voltage v′_{ab}, transformer primary current iₚ, transformer secondary current iₒ, and the output voltage vₒ, for three different transformer turns ratios n=1:1, n=2:1, and n=1:2, respectively. FIG. 9A shows experimental results showing operation in steady state conditions, and FIG. 9B highlights the effect of the distorted voltage (v′_{ab}) produced by the SSPF 20 on the load voltage (vₒ) to form the smoothed output voltage when added to/superimposed on the raw stepwise input voltage (v₁₂). This distortion is mainly affected by the intra capacitance Cu of the planar transformer. As can be seen, voltage harmonics (v′_{ab}) transform the raw stepwise AC voltage (v₁₂) into a smoothed sinusoidal AC voltage with most unwanted harmonics removed from the smoothed output voltage sent to the load. FIG. 10A shows the transient results of the start up with the input voltage ramping up from zero to rated voltage in 25 ms. FIG. 10B shows a load step transient with the load changing from 1002 to 1602.

The capacitorless solid-state power filters and power converters disclosed herein incorporate a high-frequency planar transformer to eliminate the LC filter and dc-link capacitor of conventional power filters and power converters. The high-frequency converter (e.g., the H-bridge converter operating at 30 kHz) injects voltage harmonics to produce a smoothed sinusoidal output voltage. Theoretical analysis, simulations, and experiments for a 60 Hz, 120 Vᵣₘₛ system demonstrate a low total harmonic distortion of 1.29%, meeting IEEE 519 standards. Comparative analysis with existing technology highlights a reduction in three system components: the LC filter and the dc-link capacitor.

As previously noted above, though the foregoing detailed description describes certain aspects of one or more particular embodiments of the invention, alternatives could be adopted by one skilled in the art. For example, the capacitorless solid-state power filter, power converter, and electrical power systems, and their components, could differ in appearance and construction from the embodiments described herein and shown in the drawings, functions of certain components of the capacitorless solid-state power filter, power converter, and electrical power systems could be performed by components of different construction but capable of a similar (though not necessarily equivalent) function, and various materials could be used in the fabrication of the capacitorless solid-state power filter, power converter, and electrical power systems, and/or their components. As such, and again as was previously noted, it should be understood that the invention is not necessarily limited to any particular embodiment described herein or illustrated in the drawings.

Additional details and information regarding the foregoing background and description may be found in the academic paper authored by one or more of the present inventors and entitled, “Capacitorless Solid-State Power Filter for Single-Phase DC-AC Converters,” a copy of which is appended hereto as Appendix A and the entirety of which is incorporated herein by reference. Technical publications that relate to the present disclosure are listed in Appendix A, and the contents of these publications are also incorporated herein by reference. The publications are being cited with the intent that they may help facilitate a better understanding of the disclosure, and their citation is not to be construed as an admission of prior art or what is or is not relevant prior art to the present invention.

1. A capacitorless solid-state power filter for an electrical system, the power filter comprising:
a high-frequency planar transformer having a first winding configured to receive a raw input voltage and connect with a load; and
a high-frequency converter operatively coupled to a second winding of the high-frequency planar transformer and configured to generate voltage harmonics that, when added to the raw input voltage, transform the raw input voltage into a smoothed output voltage for the load;
wherein the power filter does not include a capacitor.

2. The capacitorless solid-state power filter of claim 1, wherein:
the power filter is for a single-phase DC-to-AC converter for transforming a stepwise AC voltage into a sinusoidal AC voltage;
raw input voltage is a stepwise AC voltage;
the high-frequency converter comprises a high-frequency H-bridge converter; and
the smoothed output voltage is a sinusoidal AC voltage.

3. The capacitorless solid-state power filter of claim 1, wherein the high-frequency converter comprises:
a plurality of metal-oxide semiconductor field-effect transistors (MOSFETs), each MOSFET having a source, a drain, and a gate; and
for each MOSFET, a semiconductor diode coupled across the corresponding source and the drain in parallel with the gate.

4. The capacitorless solid-state power filter of claim 3, wherein the MOSFETs are N-channel MOSFETs.

5. The capacitorless solid-state power filter of claim 3, wherein a first MOSFET and a second MOSFET are electrically connected to a positive terminal of the second winding, and a third MOSFET and a fourth MOSFET are electrically connected to a negative terminal of the second winding.

6. The capacitorless solid-state power filter of claim 3, wherein the high-frequency converter further comprises a controller configured to control the gates of the MOSFETs to generate the voltage harmonics.

7. The capacitorless solid-state power filter of claim 1, wherein the power converter is a DC-DC power converter.

8. A power converter comprising:
a low-frequency converter configured to convert a first voltage to a raw input voltage; and
the capacitorless solid-state power filter of claim 1 operatively coupled with the low-frequency converter to receive the raw input voltage;
wherein the capacitorless solid-state power filter generates voltage harmonics that, when added to the raw input voltage, transform the raw input voltage into a smoothed output voltage for an electrical load.

9. The power converter of claim 8, wherein:
the low-frequency converter comprises a low-frequency H-bridge single-phase DC-to-AC power converter;
the first voltage is a DC voltage;
the raw input voltage is a stepwise AC voltage; and
the smoothed output voltage is a sinusoidal voltage.

10. The power converter of claim 8, wherein the low-frequency converter is configured to generate a stepwise AC voltage at a frequency in the Hz range, and wherein the capacitorless solid-state power filter is configured to generate the voltage harmonics at a frequency in the kHz range.

11. The power converter of claim 10, wherein:
the low-frequency converter is configured to generate the stepwise AC voltage at a frequency between about 10 Hz and about 900 Hz, and preferably between about 50 Hz and about 400 Hz; and
the capacitorless solid-state power filter is configured to generate the voltage harmonics at a frequency between about 10 kHz and about 90 kHz, and preferably between about 60 kHz and about 80 kHz.

12. An electrical power system comprising:
a source of raw input voltage;
the capacitorless solid-state power filter of claim 1 operatively connected to the source to receive the raw input voltage and transform the raw voltage into a smoothed output voltage; and
an electrical load operatively connected to the capacitorless solid-state power filter to receive the smoothed output voltage.

13. The electrical power system of claim 12, wherein the electrical power system comprises a marine vessel power system, and optionally wherein the marine vessel electric power system operates at about 60 Hz.

14. The electrical power system of claim 12, wherein the electrical power system comprises an aircraft power system, and optionally wherein the aircraft power system operates at about 400 Hz.

15. The electrical power system of claim 12, wherein the electrical power system comprises a photovoltaic system coupled to a utility power grid, and optionally wherein the utility power grid operates at between about 50 Hz and about 60 Hz.
